(19) United States
(12) Patent Application Publication
(10) Pub. No.: US 2013/0132740 A1
(43) Pub. Date: May 23, 2013

(54) Power Control for Memory Devices

(71) Applicant: Jengluen Li, San Jose, CA (US)

(72) Inventor: Jengluen Li, San Jose, CA (US)

(73) Assignee: O2Micro, Inc., Santa Clara, CA (US)

(21) Appl. No.: 13/303,906

(22) Filed: Nov. 23, 2011

(51) Int. Cl. G06F 1/26

(52) U.S. Cl. 713/300

(57) ABSTRACT

A power controller is configured to deliver different power levels to different types of memory devices. The power controller includes a selecting unit to select a control mode that controls power delivered to a memory device. The selecting unit includes a first input configured to receive a mode signal, multiple control inputs configured to receive several control mode signals, and multiple outputs configured to output power to the memory device. The selecting unit selects the control mode according to the received mode signal and outputs power according to the control modes signals.

### BACKGROUND

Nowadays, memory devices such as memory cards are commonly used in many electronic devices, including digital cameras, camcorders, mobile phones, laptop computers, and video game consoles, etc. A memory card or flash media card is a re-recordable electronic data storage device used for storing digital information. Memory cards include but are not limited to memory stick card, secure digital memory card (SD card), xD-picture card, MultiMediaCard (MMC), embedded MultiMediaCard (eMMC), CompactFlash card (CF card), etc.

Under certain circumstances, two or more memory cards having similar interface protocols can share one integrated interface to support those memory cards. For example, SD card, MMC and eMMC have similar interface protocols which use 1 CLOCK, 1 COMMAND and 4 (for SD) or 8 (for MMC/eMMC) DATA lines to communicate or transfer data between host and memory cards through memory card adapters. Accordingly, most of MMC/eMMC/SD card share one integrated interface that support these three different types of memory cards. The integrated interface can provide more flexibility for system application.

Though some of the memory cards have similar interface protocols, the power control protocols for controlling these memory cards can be different. As a result, a chip packaged using the memory card adapter requires extra pins to control individually power delivered to each type of memory card. For instance, the SD and eMMC specifications each defines two power control signals. Specifically, the SD card specification defines a pair of power control signals VDD1 (3.3V) and a VDD2 (1.8V) for powering an SD card, and the eMMC specification defines a pair of power control signals VCC (3.3V) and VCCQ (3.3V/1.8V) for powering an eMMC. Thus, a single SD card/eMMC card adapter chip requires two sets of pins (that means four pins corresponding to VDD1, VDD2, VCC and VCCQ, respectively) to control power even SD and eMMC are active mutually exclusively. The use of extra pins and the related cost raise concern when the chip size and circuit board space are critical in certain tight budget circumstances.

### SUMMARY

A power controller is configured to deliver different power levels to different types of memory devices. The power controller includes a selecting unit to select a control mode that controls power delivered to a memory device. The selecting unit includes a first input configured to receive a mode signal, multiple control inputs configured to receive several control mode signals, and multiple outputs configured to output power to the memory device. The selecting unit selects the control mode according to the received mode signal and outputs power according to the control modes signals.

In another embodiment, the invention is a power control system with a power controller and a switch. The power controller controls the power delivered to a memory device and outputs a plurality of power control signals to control the memory device. The power controller selects a control mode that controls the power delivered to the memory device from a plurality of control modes. The switch unit, coupled to the power controller and a plurality of power supplies, outputs the power to the memory device according to the power control signals.

In yet another embodiment, the invention is a method for delivering power, through a power controller, to a memory device. The method includes receiving, through an input on the power controller, a mode signal that defines a predetermined control mode corresponding to a memory device, selecting the predetermined control mode from a plurality of control modes according to the mode signal, wherein the control modes control delivery of power to a plurality of memory devices, and outputting a plurality of power control signals corresponding to the control mode.

### BRIEF DESCRIPTION OF THE DRAWINGS

Features and advantages of embodiments of the claimed subject matter will become apparent as the following detailed description proceeds, and upon reference to the drawings, wherein like numerals depict like parts, and in which:

FIG. 1 shows a diagram of a power controller, in accordance with one embodiment of the present invention.

FIG. 2 shows a diagram of a power controller, in accordance with an alternative embodiment of the present invention.

FIG. 3 shows a block diagram for a power control system, in accordance with one embodiment of the present invention.

FIG. 4 shows a diagram of a memory card adapter, in accordance with one embodiment of the present invention.

FIG. 5 shows a flowchart of a method for controlling power to a memory card, in accordance with one embodiment of the present invention.

FIG. 6 shows a flowchart of a method for controlling a memory card, in accordance with one embodiment of the present invention.

### DETAILED DESCRIPTION

Reference will now be made in detail to the embodiments of the present invention. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims.

Furthermore, in the following detailed description of the present invention, numerous specific details are set forth in order to provide a thorough understanding of the present invention. However, it will be recognized by one of ordinary skill in the art that the present invention may be practiced without these specific details. In other instances, well known methods, procedures, components, and circuits have not been described in detail as not to unnecessarily obscure aspects of the present invention.

According to one embodiment of the present invention, a memory card adapter including a power controller that is capable of controlling power delivered to different types of memory cards is disclosed. Advantageously, the power controller is capable of employing one set of power control signals to deliver power to different memory cards. As such, when the memory card adapter is packaged into a memory card adapter chip, chip pins on the memory card adapter chip for controlling power can be shared by different memory cards. Consequently, power control functionality of the memory card adapter chip can be improved while the cost can be reduced. At the same time, the space on the circuit board that integrates the memory card adapter can be saved.

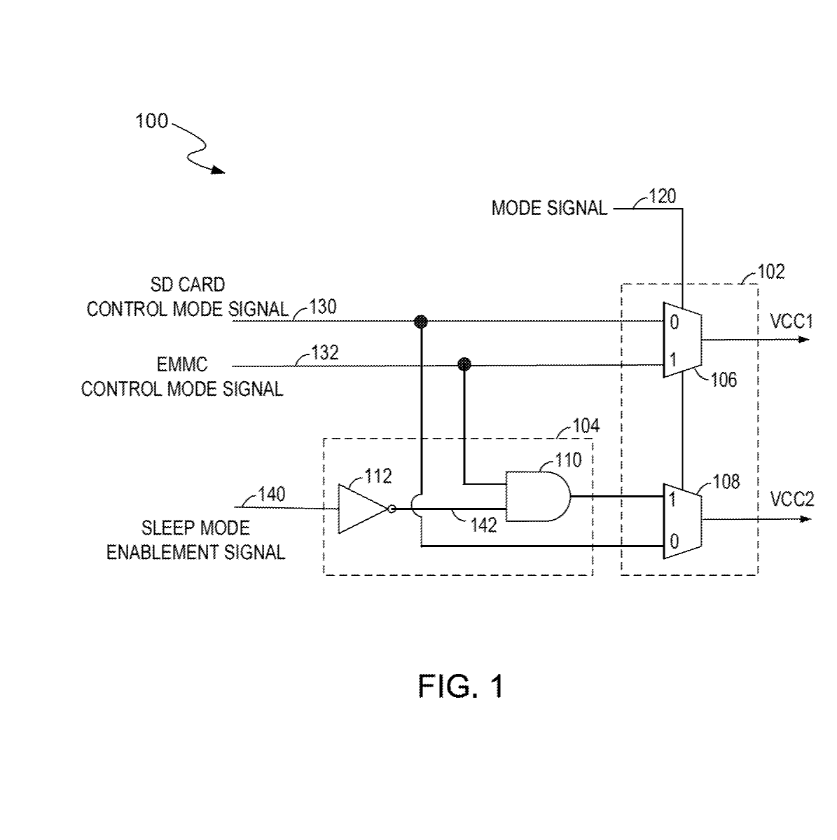

FIG. 1 shows a diagram of a power controller 100, in accordance with one embodiment of the present invention. The power controller 100 includes a selecting unit 102 and a sleep mode controller 104. The selecting unit 102 can select a control mode from two control modes: a first control mode and a second control mode. The first control mode may be an eMMC control mode and is enabled by eMMC control mode signal 132, and the second control mode may be a SD control mode and is enabled by SD card control mode signal 130. The selecting unit 102 outputs a pair/set of power control signals VCC1 and VCC2 corresponding to the selected control mode. A mode signal 120 is coupled to the selecting unit 102 to select the control mode. The selecting unit 102 comprises two selectors 106 and 108, and each selector includes a “1” status and a “0” status. The SD card control mode signal 130 and the eMMC control mode signal 132 are coupled to the “0” status and the “1” status, respectively. Thus, when the mode signal 120 selects the “0” status, the SD card control mode is selected, and the power control signals VCC1 and VCC2 are output according to the SD card control mode signal 130. Similarly, when the mode signal 120 selects the “1” status, the eMMC control mode is selected and the power control signals VCC1 and VCC2 are output according to the eMMC control mode signal 132.

The power controller 100 can control power delivered to a memory card corresponding to a predetermined control mode. For example, if the predetermined control mode is the SD card control mode, the mode signal 120 controls the selecting unit 102 and selects the SD card control mode. The power controller 100 then controls power to a SD card. In other words, the power controller 100 can be utilized as a SD card power controller. Similarly, if the eMMC control mode is selected, the power controller 100 can be utilized as an eMMC power controller.

Advantageously, since the power controller 100 employs one set of power control signals VCC1 and VCC2 to control power delivered to the SD card and the eMMC, when the memory card adapter (not shown in FIG. 1) that integrates the power controller 100 is packaged into a memory card adapter chip, compared to the conventional memory card adapter chip that employs 4 pins to individually control power delivered to the SD card and the eMMC, only 2 pins are required. Consequently, the chip size and the circuit board space can be reduced.

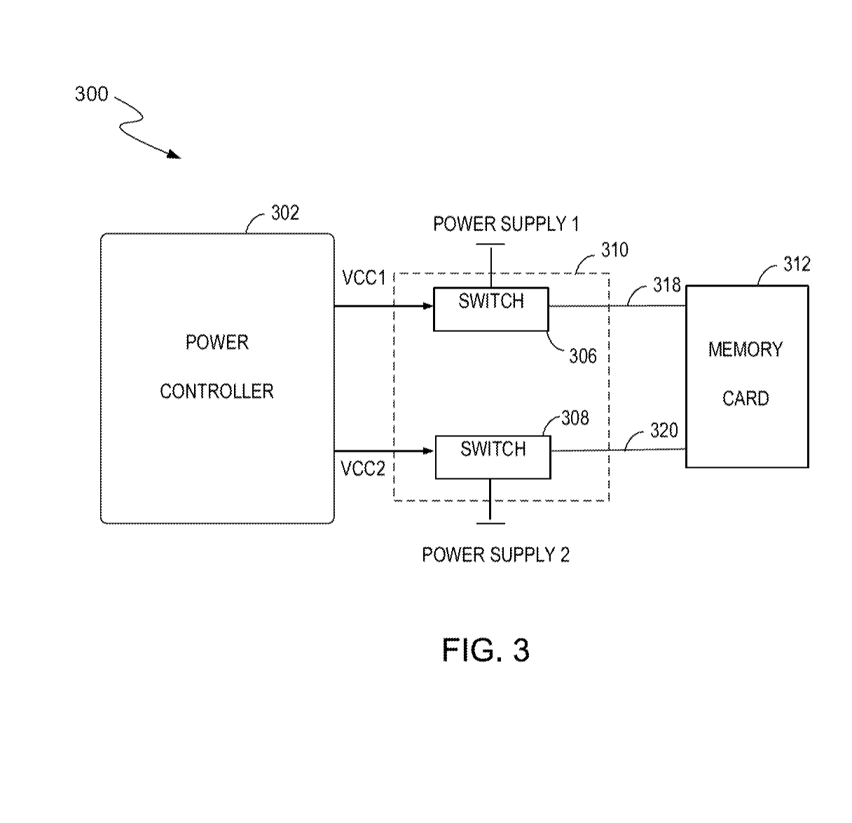

In one embodiment, when a control mode is selected and the power controller 100 operates in a normal operation mode, the power control signals VCC1 and VCC2 are configured to be both logic 1 to enable a set of power supplies (as will be described in details in FIG. 3) to power the memory card.

In another embodiment, if the selected control mode supports a sleep mode function, the power controller 100 can further include a sleep mode controller 104 which is coupled to the selecting unit 102 to operate the power controller 100 in a sleep mode. In the sleep mode, the sleep mode controller 104 sets either the power control signals VCC1 or VCC2 to logic 0. By not enabling all the power supplies to power the memory card, the power controller 100 operates in the sleep mode. For instance, the eMMC specification defines a sleep mode function to save power consumption. When the eMMC control mode is selected, the sleep mode controller 104 can be enabled to switch the power controller 100 into a sleep mode. The sleep mode controller 104 includes a combination unit, e.g., an AND gate 110 and a reverse unit, e.g., a NOT gate 112. The AND gate 110 is coupled to the selecting unit 102 to set the pair of power control signals VCC1 and VCC2 to the sleep mode according to a sleep mode control signal 142. The NOT gate 112 is coupled to the AND gate 110 to generate the sleep mode control signal 142 according to a sleep mode enablement signal 140. In one embodiment, when the eMMC control mode is selected and the power controller 100 is utilized as an eMMC power controller, the sleep mode enablement signal 140 can be set as logic 1 to enable the sleep mode of the eMMC. Upon receiving the sleep mode enablement signal 140 valued as logic 1, the NOT gate 112 outputs the sleep mode control signal 142 as logic 0. Consequently, the AND gate 110 outputs a logic 0 to the selector 108 and the power control signal VCC2 is set to logic 0 to realize the sleep mode function accordingly. Alternatively, if the mode signal 120 selects the SD card mode, the power control signals VCC1 and VCC2 are generated regardless of the value of the sleep mode enablement signal 140.

In another embodiment, when the power controller 100 selects from the first and the second control modes and both modes support sleep mode function, the power controller 100 can include two sleep mode controllers (not shown in FIG. 1). Each sleep mode controller associates to one control mode and switches the power controller 100 to a sleep mode when the corresponding control mode is selected. For example, a second sleep mode controller (not shown in FIG. 1) for setting the second control mode to a sleep mode can be coupled to the selecting unit 102 with a similar topology as the sleep mode controller 104.

Advantageously, as the power controller 100 employs the sleep mode controller 104, the sleep mode function of the selected memory card control mode can be realized. The power consumption can be reduced accordingly.

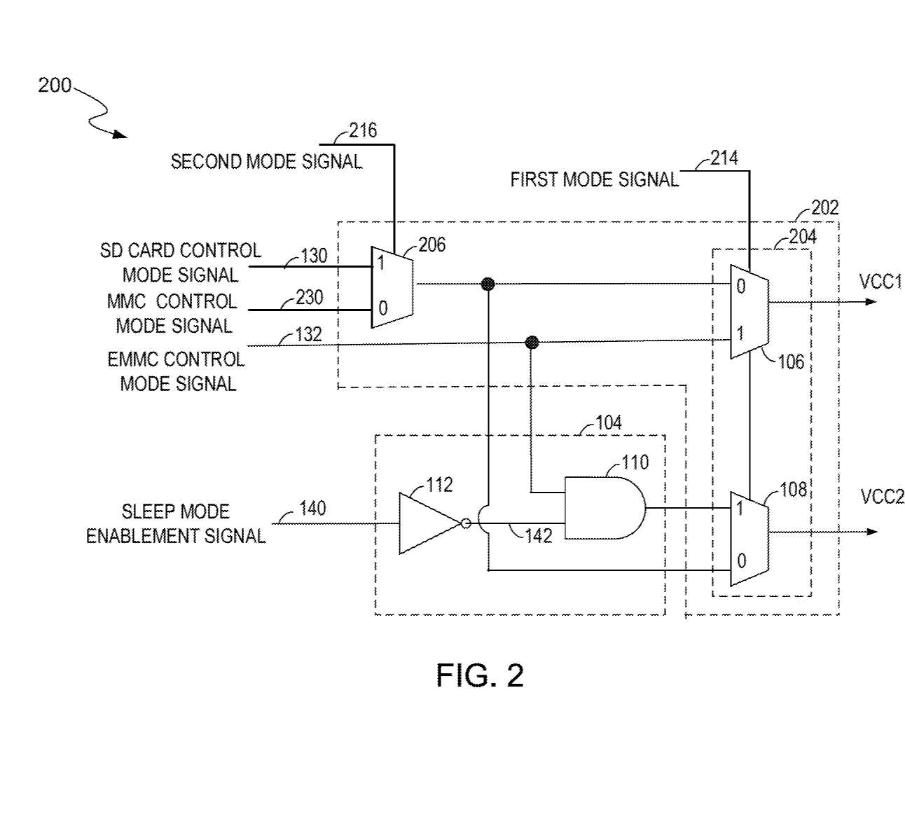

FIG. 2 shows a diagram of a power controller 200, in accordance with another embodiment of the present invention. Elements that are labeled the same as in FIG. 1 have similar functions and will not be described herein. The power controller 200 includes a selecting unit 202 and a sleep mode controller 104. The selecting unit 202 can select a control mode from three control modes: a first control mode, a second control mode and a third control mode. The third control mode may be a MMC control mode and is enabled by MMC control mode signal 230. The selecting unit 202 outputs a pair/set of power control signals VCC1 and VCC2. The selecting unit 202 includes a first stage selector 204 and a second stage selector 206. A first mode signal 214 and a second mode signal 216 are configured to control the first stage selector 204 and the second stage selector 206, respectively. In one embodiment, the second stage selector 206 selects a selected control mode from two control modes, e.g., the SD card control mode and the MMC control mode. The first stage selector 204 selects a control mode from the selected control mode (e.g., the SD card control mode) and the eMMC control mode.

In one embodiment, the selecting unit 202 of the power controller 200 can further include a third stage selector (not shown in FIG. 2) etc. The number of the stage selectors can be determined based on the number of control modes that the power controller 200 supported, e.g., N power control modes requires N-1 stage selectors (where N is an integer and N≧2). Each stage selector can select a selected control mode from two control modes and a next stage selector then selects a control mode between the selected control mode and another control mode. Ultimately, the first stage selector 204 outputs the power control signals VCC1 and VCC2 according to the predetermined control mode.

Therefore, the power controller 200 can be employed to control the power delivered to multiple types of memory cards according to one set of power control signals. Advantageously, the pin number and size of the memory card adapter can be further reduced.

When a control mode supports the sleep mode function, the sleep mode controller 104 can be enabled to switch the power controller 200 into the sleep mode. By way of example, when the first stage selector 204 selects the eMMC control mode and the eMMC control supports the sleep mode, the sleep mode controller 104 can be enabled to switch the eMMC power controller 100 into the sleep mode.

In one embodiment, when the first stage selector 214 selects between two control modes, both supporting sleep mode functions, the power controller 200 can include two sleep mode controllers (not shown in FIG. 2), both coupled to the first stage selector 204. Each sleep mode controller corresponds to one control mode and switches the power controller 200 to a sleep mode when the corresponding control mode is selected.

FIG. 3 shows a diagram of a power control system 300, in accordance with one embodiment of the present invention. FIG. 3 is described in combination with FIG. 1 and FIG. 2. The power control system 300 includes a switch unit 310 and a power controller 302 that can be either the power controller 100 from FIG. 1 or the power controller 200 from FIG. 2. In one embodiment, the power controller 302 controls the power to a memory card 312 and outputs the power control signals VCC1 and VCC2 to control the power delivered to the memory card 312. The switch unit 310 is coupled to the power controller 302 and configured to switch on/off a pair/set of power supplies that includes a power supply 1 and a power supply 2 according to the power control signals VCC1 and VCC2. The switch unit 310 also outputs voltage signals 318 and 320 for control the memory card 312.

In one embodiment, when a control mode, e.g., the eMMC control mode, is selected, the power controller 302 can be utilized as an eMMC power controller and the eMMC control mode signal 132 is set to logic 1. The power control signals VCC1 and VCC2 are generated according to the eMMC control mode signal 132. As described in FIG. 1 and FIG. 2, in a normal operation mode, when the eMMC control mode signal 132 is set to logic 1, the power control signals VCC1 and VCC2 both output logic 1. The switches 306 and 308 are enabled accordingly. As mentioned above, the eMMC specification requires the pair of power control signals VCC (3.3V) and VCCQ (3.3V/1.8V) to power the eMMC. The power supply 1 and power supply 2 can be preset as 3.3V and 3.3V/1.8V respectively to fulfill the requirement of the specification. Accordingly, when the switches 306 and 308 are enabled, the voltage signal 318 that corresponds to the VCC (3.3V) and the voltage signal 320 that corresponds to the VCCQ (3.3V/1.8V) can be generated to control the eMMC card.

In one embodiment, due to the enablement of the sleep mode enablement signal 140 in FIG. 2, the power controller 302 is operated in the sleep mode. The power control signal VCC2 is thus set to logic 0 such that the switch 308 is disabled and the voltage signal 320 is lower than the required voltage VCCQ. By not powering the eMMC with both VCC and VCCQ at the required power level, the power controller 302 operates in the sleep mode.

In another embodiment, when a control mode, e.g., the SD card control mode, is selected, the power controller 302 can be utilized as an SD card power controller. Similarly, since the SD card specification defines power levels of the VDD1 (3.3V) and the VDD2 (1.8V) for powering the SD card. The power supply 1 and power supply 2 can be preset as 3.3V and 1.8V, respectively, and the selection process described in the previous paragraph is repeated for the SD card control mode.

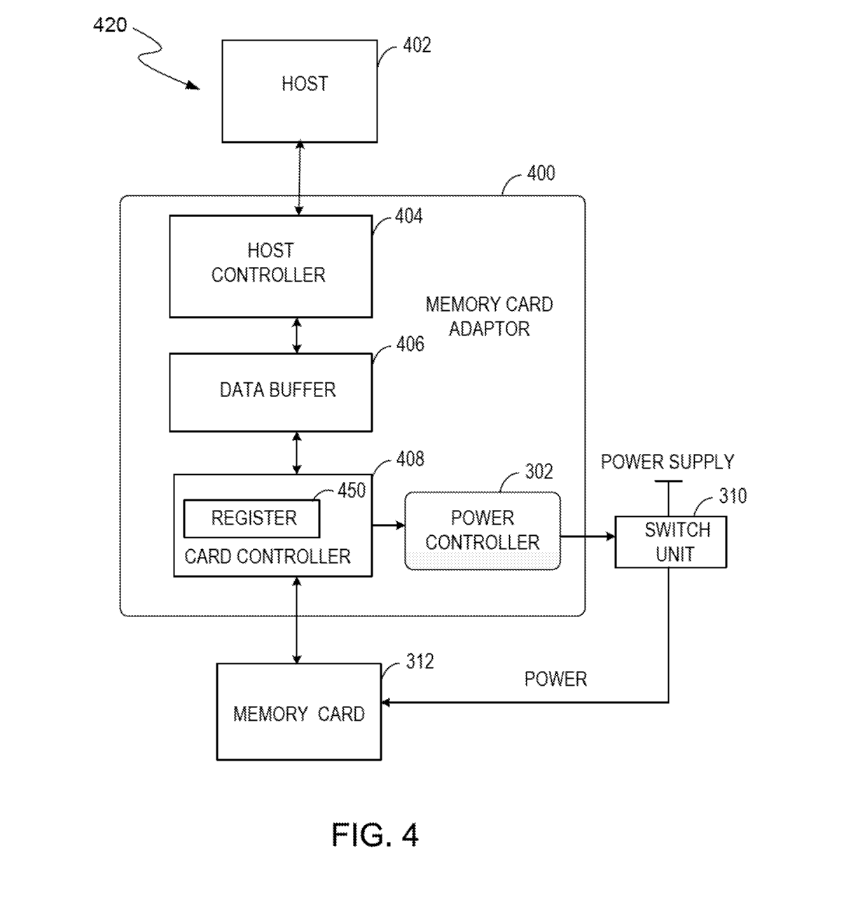

FIG. 4 shows a diagram of a memory card adapter 400, in accordance with one embodiment of the present invention. FIG. 4 is described in combination with FIG. 1, FIG. 2 and FIG. 3. Elements that are labeled the same as in FIG. 3 have similar functions and will not be described herein. The memory card adapter 400 is mounted on a circuit board 420. The circuit board 420 further includes a host 402 and the switch unit 310. The circuit board 420 is coupled to a power supply. In one embodiment, the circuit board 420 may further include the memory card 312, such as an eMMC that is defined to be integrated on a circuit board. In another embodiment, the memory card 312, e.g., an SD card, can be inserted into a slot on the circuit board 420. The memory card adapter 400 exchanges control signals and data information between the host 402 and the memory card 312. In one embodiment, the memory card adapter 400 includes a power controller 302, a host controller 404, a data buffer 406 and a card controller 408. The host controller 404 supports the same interface protocol as the host 402. The host controller 404 interprets the control signals from the host 402, stores the data received from the host 402 in the data buffer 406, and forwards data retrieved from the data buffer 406 to the host 402. The data buffer 406 is configured to temporarily store data from the host 402 and the card controller 408. The card controller 408 supports the same interface protocol as the memory card 312. The card controller 408 controls the memory card based on the control signals from the host 402, writes data to and reads data from the memory card 312.

The register 450 in the card controller 408 generates the mode signal 120 in FIG. 1 or the mode signals 214 and 216 in FIG. 2. A driver of the memory card adapter chip or a system initialization program in the host 402 can set the register 450. In one embodiment, the driver or the system initialization program set certain bits in the register 450 according to memory card type the circuit board 420 is set to support, and the register 450 generates the mode signal 120 according to the set bits. Accordingly, a memory card adapter chip packaged using the memory card adapter 400 is capable of providing power to different memory cards. Accordingly, the memory card adapter chip utilizes one set of chip pins to control power to different types of memory cards.

After the memory card adapter chip is mounted to the circuit board 420, the power supplies in FIG. 3 are set according to the memory card that the circuit board 420 is set to support. In other words, the circuit board 420 can support a certain type of memory card and the power supplies are set according to this type of memory card. For instance, if the circuit board 420 is set to support the SD card, the power supplies are preset as 3.3V (VDD1) and 1.8V (VDD2); if the circuit board is set to support the eMMC, the power supplies are preset as 3.3V (VCC) and 3.3V/1.8V (VCCQ). As the eMMC specification defines two levels of VCCQ (3.3V or 1.8V), the voltage level of VCCQ can be chosen in advance. The power supply 2 in FIG. 3 on circuit board can be set accordingly.

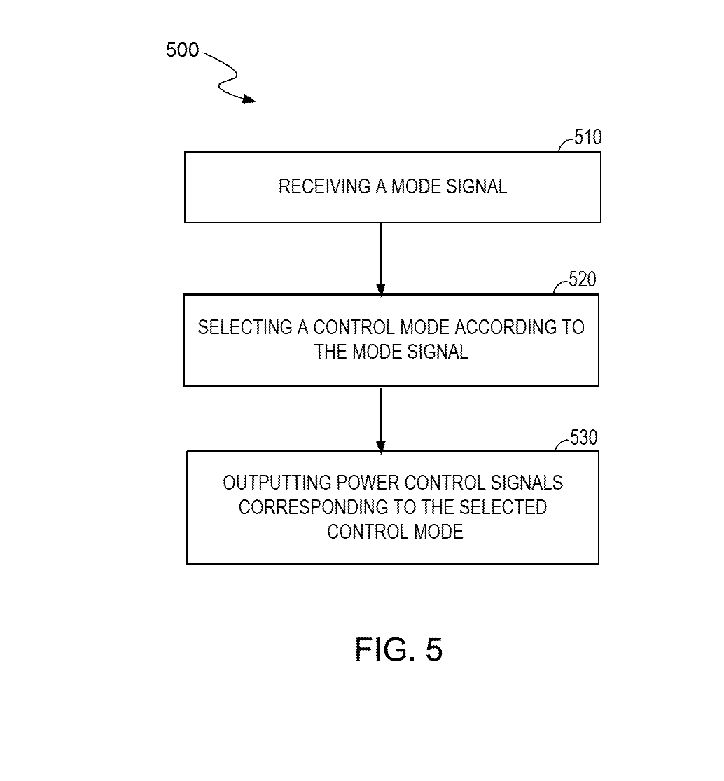

Referring to FIG. 5, a method 500 for controlling power is illustrated, in accordance with one embodiment of the present invention. Although specific steps are disclosed in FIG. 5, such steps are just examples. That is, the present invention is well suited to performing various other steps or variations of the steps recited in FIG. 5. FIG. 5 is described in combination with FIG. 1 and FIG. 2.

In block 510, a mode signal 120 is received by the selecting unit 102 in FIG. 1 or a first and a second mode signals 204 and 206 are received by the selecting unit 202 in FIG. 2. The mode signals are set to select a certain type of control mode for controlling power delivered to one type of memory card. For example, in FIG. 1, the mode signal 120 is set to 1 to select the eMMC control mode.

In block 520, the control mode is selected from several control modes by the power controller 100 or the power controller 200 according to the mode signal 120 or the first and second mode signals 204 and 206. In those control modes, the power controller 100 or 200 can be utilized to control the power delivered to different types of memory cards. In one embodiment, the selecting unit 102 in FIG. 1 and the selecting unit 202 in FIG. 2 are configured to select a certain type of control mode according to the mode signals. For example, the determined certain type of control mode is eMMC control mode. In FIG. 1, the selecting unit 102 includes two selectors 106 and 108 to select the eMMC control mode. In FIG. 2, the selecting unit 202 includes the second stage selector 206 to select a selected control mode, e.g., the SD card control mode, from two control modes, e.g., the SD card control mode and the MMC control mode. The selecting unit 202 further includes the first stage selector 206 to select the eMMC control mode between the selected SD card control mode and the eMMC control mode.

In block 530, the power control signals VCC1 and VCC2 corresponding to the control mode are output. In one embodiment, when the eMMC control mode is selected, the power control signals VCC1 and VCC2 are generated based on the eMMC control mode signal 132. In one embodiment, when the selected control mode supports the sleep mode function, a sleep mode enablement signal 140 is received to set the power control signals VCC1 and VCC2 into the sleep mode. For instance, the eMMC specification defines a sleep mode function to save power consumption. When the eMMC control mode is selected, the sleep mode enablement signal 140 can set either the power control signals VCC1 or VCC2 to logic “0”.

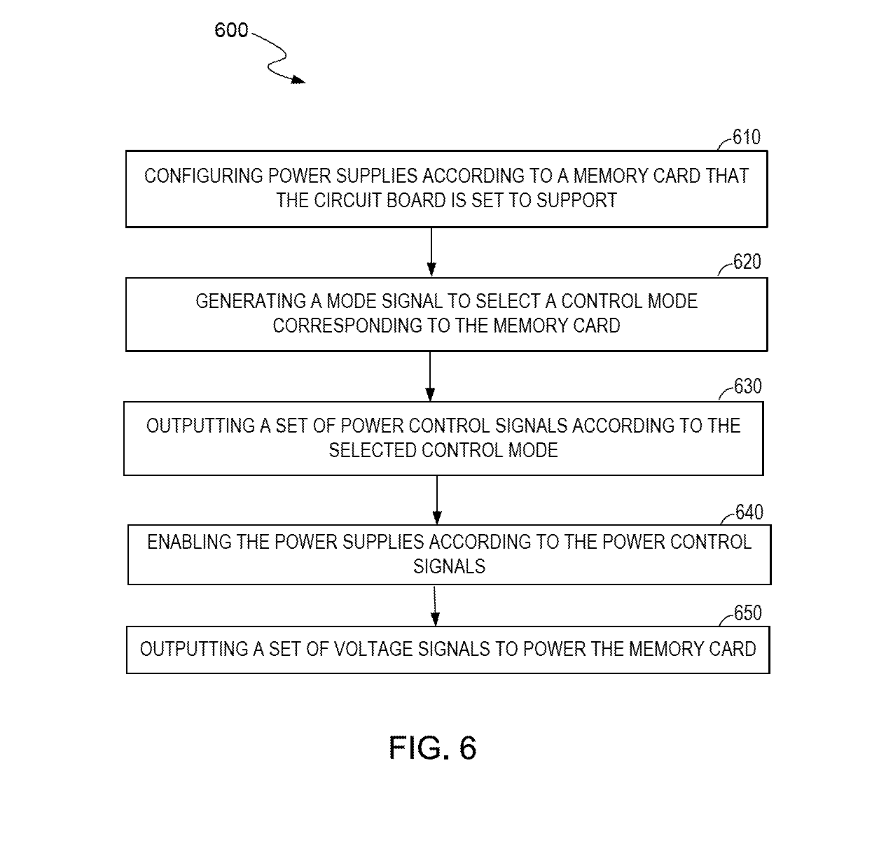

Referring to FIG. 6, a method 600 for controlling a memory card is illustrated, in accordance with one embodiment of the present invention. Although specific steps are disclosed in FIG. 6, such steps are just examples. That is, the present invention is well suited to performing various other steps or variations of the steps recited in FIG. 6. FIG. 6 is described in combination with FIG. 1, FIG. 2, FIG. 3 and FIG. 4.

In block 610, power supplies on a circuit board 420 in FIG. 4 is set. The power supplies may be the power supply 1 and power supply 2 in FIG. 3 and are configured according to a memory card that the circuit board 420 is set to support. For example, when the circuit board 420 is set to support a SD card, the power supply 1 is set to 3.3V and the power supply 2 is set to 1.8V.

In block 620, a mode signal 120 or a first and a second mode signals 204 and 206 is/are generated by the register 450 in the memory card adapter 400 in FIG. 4. The mode signals are generated to select a control mode corresponding to the memory card that the circuit board 420 is set to support. For example, when the circuit board 420 is set to support a SD card and the SD card control mode is to be selected, the mode signal 120 in FIG. 1 is set to logic 0.

In block 630, a set of power control signals VCC1 and VCC2 is output by the power controller 402 according to the selected control mode. For example, when the SD card control mode is selected, the SD card control mode signal 130 is set to logic 1. The power controller 100 outputs the power control signals VCC1 and VCC2 that are both set to logic 1. In one embodiment, when the memory card, e.g., the eMMC, supports the sleep mode, the sleep mode controller 104 configures either the power control signals VCC1 or VCC2 to logic 0.

In block 640, the power supplies are enabled according to the power control signals VCC1 and VCC2. As mentioned above, since the power control signals VCC1 and VCC2 are both set to logic 1, the switches 306 and 308 in the switch unit 310 are switched on and the power supplies are enabled accordingly.

In block 650, a set of voltage signals 318 and 320 are output to power the memory card. In the eMMC sleep mode, one of the power control signals is set to logic 0 and one of the power supplies is disabled. By not powering the eMMC with both voltage signals at the required power level, the power controller 302 operates in the sleep mode.

While the foregoing description and drawings represent embodiments of the present invention, it will be understood that various additions, modifications and substitutions may be made therein without departing from the spirit and scope of the principles of the present invention as defined in the accompanying claims. One skilled in the art will appreciate that the invention may be used with many modifications of form, structure, arrangement, proportions, materials, elements, and components and otherwise, used in the practice of the invention, which are particularly adapted to specific environments and operative requirements without departing from the principles of the present invention. The presently disclosed embodiments are therefore to be considered in all respects as illustrative and not restrictive, the scope of the invention being indicated by the appended claims and their legal equivalents, and not limited to the foregoing description.

What is claimed is:

1. A power controller, for controlling power delivered to different types of memory devices, comprising:
a selecting unit for selecting a control mode that controls power delivered to a memory device, the selecting unit having a first input for receiving a mode signal, a plurality of control inputs for receiving a plurality of control mode signals, and a plurality of outputs for outputting power to the memory device,
wherein
the selecting unit selects the control mode according to the received mode signal and outputs power according to the plurality of control mode signals, and
the power controller delivers different power levels to different types of memory devices.

2. The power controller of claim 1, further comprising:
a sleep mode controller coupled to the selecting unit, the selecting unit having a second input for receiving a sleep mode control signal.

3. The power controller of claim 2, wherein the sleep mode controller further comprises:
a combination unit coupled to the selecting unit and for receiving the sleep mode control signal, and for setting the power control signals to the sleep mode according to the sleep mode control signal, wherein one of the plurality of outputs is set to logic 0 in the sleep mode.

4. The power controller of claim 3, wherein the sleep mode controller further comprises:
a reverse unit, coupled to the combination unit, for receiving a sleep mode enablement signal and generating the sleep mode control signal according to the sleep mode enablement signal.

5. The power controller of claim 1, wherein the control modes comprises a SD card control mode and an EMMC card control mode.

6. The power controller of claim 1, wherein the selecting unit further comprises a plurality of stage selectors, each stage selector receives two of the control mode signals and outputs a selected control mode signal according to the mode signal.

7. The power controller of claim 1, wherein the selecting unit further comprises a first stage selector for receiving two of the control mode signals and selecting a control mode signal corresponding to the control mode according to the mode signal, and for outputting the power according to the control mode signal.

8. The power controller of claim 6, further comprising:
a sleep mode controller coupled to the selecting unit, the selecting unit having a second input for receiving a sleep mode control signal.

9. The power controller of claim 6, wherein said selecting unit further comprises a plurality of inputs for receiving a plurality of mode signals, wherein each stage selector selects the selected control mode signal according to one of the plurality of mode signals.

10. A power control system, comprising:
a power controller for controlling power delivered to a memory device and outputting a plurality of power control signals to control the memory device, wherein the power controller selects a control mode that controls power delivered to the memory device from a plurality of control modes; and
a switch unit, coupled to the power controller and a plurality of power supplies, for outputting power to the memory device according to the power control signals.

11. The power control system of claim 10, wherein the power controller comprises:
a selecting unit for selecting the control mode, the selecting unit having a first input for receiving a mode signal, a plurality of control inputs for receiving a plurality of control mode signals, and a plurality of outputs for outputting power to a memory device,
wherein
the selecting unit selects the control mode according to the received mode signal and outputs the plurality of voltage signals according to the plurality of control mode signals, and
the power controller delivers different power levels to different types of memory devices.

12. The power control system of claim 10, wherein the switch unit comprises a plurality of switches, each switch receives one of the power supplies and outputs power according to one of the plurality of power control signals.

13. A memory card adapter, comprising:
a card controller for controlling a memory device according to a plurality of control signals sent from a host; and
a power controller coupled to the card controller, for selecting a control mode that controls power delivered to the memory device from a plurality of control modes.

14. The memory card adapter of claim 13, wherein the memory card adapter further comprising:
a host controller, coupled to the host, for interpreting the control signals; and
a data buffer coupled to the host controller and the card controller, for storing data exchanged between the host controller and the card controller.

15. The memory card adapter of claim 13, wherein the power controller comprises:
a selecting unit for selecting the control mode, the selecting unit having a first input for receiving a mode signal, a plurality of control inputs for receiving a plurality of control mode signals, and a plurality of outputs for outputting power to the memory device,
wherein
the selecting unit selects the control mode according to the received mode signal and outputs power according to the plurality of control mode signals, and
the power controller delivers different power levels to different types of memory devices.

16. A method for delivering power, through a power controller, to a memory device, comprising:
receiving, through an input on the power controller, a mode signal that defines a predetermined control mode corresponding to a memory device;
selecting the predetermined control mode from a plurality of control modes according to the mode signal, wherein the control modes control delivery of power to a plurality of memory devices; and
outputting a plurality of power control signals corresponding to the control mode.

17. The power control method of claim 16, further comprising:
enabling a sleep mode of the predetermined control mode, through a sleep mode controller, wherein one of the plurality of power control signals is set to logic 0 in the sleep mode.

18. The power control method of claim 16, further comprising:
selecting a selected control mode between two of the control modes; and
selecting the predetermined control mode between the selected control mode and another one of the control modes.

19. The power control method of claim 18, further comprising:
enabling a sleep mode of the predetermined control mode, through a sleep mode controller, wherein one of the plurality of power control signals is set to logic 0 in the sleep mode.

20. The power control method of claim 16, further comprising:
enabling a plurality of switches according to the plurality of power control signals; and
generating a plurality of voltage signals according to a plurality of power supplies if the plurality of switches are enabled.
